(19) United States
(12) Patent Application Publication
(10) Pub. No.: US 2010/0329767 A1
(43) Pub. Date: Dec. 30, 2010

(54) TAPE CASSETTE

(75) Inventors: Akira SAGO, Seto-shi (JP); Susumu MURATA, Konan-shi (JP); Yasuhiro SHIBATA, Okazaki-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA, Nagoya-shi (JP)

(21) Appl. No.: 12/817,556

(22) Filed: Jun. 17, 2010

(30) Foreign Application Priority Data
Jun. 30, 2009 (JP) 2009-156282
Dec. 28, 2009 (JP) 2009-297502

(51) Int. Cl. B41J 11/00

(52) U.S. Cl. 400/613

(57) ABSTRACT

A tape cassette that includes a cassette case, a printing tape fed along a specified first feed path, a double-sided adhesive tape fed along a specified second feed path, a cylindrical tape feed roller that guides the double-sided adhesive tape along a section of its outer circumferential surface, a laminated tape restricting member provided on a downstream side of the tape feed roller on the first feed path and the second feed path and at downstream ends of the first feed path and the second feed path where the first feed path and the second feed path overlap each other, and an adhesive tape restricting member disposed to oppose the section of the outer circumferential surface and apart from the outer circumferential surface by a distance that is shorter than a length of the channel of the laminated tape restricting member.

### CROSS-REFERENCE TO RELATED APPLICATIONS

This application claims priority to Japanese Patent Application No. 2009-156282 filed on Jun. 30, 2009, and also claims priority to Japanese Patent Application No. 2009-297502 filed on Dec. 28, 2009. The disclosure of the foregoing applications is herein incorporated by reference in its entirety.

### BACKGROUND

The present disclosure relates to a tape cassette that can be installed in and removed from a tape printer.

A box-shaped tape cassette is known that can be installed in and removed from a cassette housing portion of a tape printer. Inside the tape cassette, a printing tape as a print medium and a double-sided adhesive tape to be affixed to the printing tape are contained. The printing tape is fed along a specified feed path in the tape cassette, and characters such as letters are printed on the tape by a printhead of the tape printer. The double-sided adhesive tape, which has a release paper affixed on one surface, is fed in the tape cassette along another feed path that is different from the feed path of the printing tape. The other surface of the double-sided adhesive tape is affixed to the printing tape on which the characters have been printed. The printing tape to which the double-sided adhesive tape has been affixed is discharged to the outside through a tape discharge outlet of the tape cassette. A user can use the discharged tape as desired.

### SUMMARY

With the tape cassette described above, an external force may be applied to the tape discharged from the tape cassette and the like. As a result, the tape may be pushed upstream in a feed direction of the tape. In such a case, the printing tape to which the double-sided adhesive tape is affixed, and the printing tape and the double-sided adhesive tape before being affixed may bend and go off the respective paths. Consequently, the tape may not be discharged from the tape cassette correctly or printing may not be performed correctly.

Various exemplary embodiments of the general principles described herein provide a tape cassette in which a printing tape to which a double-sided adhesive tape is affixed, the printing tape and the double-sided adhesive tape before being affixed can go back to respective feed paths of the tapes after these tapes have been pushed upstream in relation to a feed direction of the tapes.

The exemplary embodiments provide a tape cassette that includes a cassette case, a printing tape, a double-sided adhesive tape, a cylindrical tape feed roller, a laminated tape restricting member, and an adhesive tape restricting member. The cassette case has a top face, a bottom face, and a side face. The printing tape is a printing medium that is mounted within the cassette case and fed along a specified first feed path within the cassette case. The double-sided adhesive tape is mounted within the cassette case and fed along a specified second feed path within the cassette case. The double-sided adhesive tape has two surfaces. One of the two surfaces has a release material removably affixed thereto, and the other of the two surfaces is affixable to the printing tape. The tape feed roller has an outer circumferential surface and an axis extending in a vertical direction of the cassette case. The tape feed roller is supported by the cassette case, and guides the double-sided adhesive tape along a section of the outer circumferential surface on the second feed path. A length of the section in a circumferential direction is equal to or longer than a quarter of a length of the outer circumferential surface in the circumferential direction. The laminated tape restricting member is provided on a downstream side of the tape feed roller on the first feed path and the second feed path, and at downstream ends of the first feed path and the second feed path where the first feed path and the second feed path overlap each other. The laminated tape restricting member includes a first member, a second member, a channel, and a tape discharge outlet. The first member that has a first face and the second member has a second face that is generally parallel to the first face. The second member is disposed to oppose the first member in a position that is farther from the tape feed roller than is the first member. The channel is formed between the first face of the first member and the second face of the second member. An upstream edge of the second face in a feed direction of a laminated tape passing through the channel is located farther downstream than an upstream edge of the first face in the feed direction. The laminated tape is a tape formed by the printing tape and the double-sided adhesive tape affixed to the printing tape. The tape discharge outlet is located at a downstream end of the channel, and the laminated tape is discharged through the tape discharge outlet to an outside of the cassette case. The adhesive tape restricting member is disposed to oppose the section of the outer circumferential surface along which the double-sided adhesive tape is guided, and is disposed apart from the outer circumferential surface by a distance that is shorter than a length of the channel of the laminated tape restricting member.

The exemplary embodiments also provide a tape cassette that includes a cassette case, a printing tape, a double-sided adhesive tape, a cylindrical tape feed roller, a laminated tape restricting member, and an adhesive tape restricting member. The cassette case has a top face, a bottom face, and a side face. The printing tape is a printing medium that is mounted within the cassette case and fed along a specified first feed path within the cassette case. The double-sided adhesive tape is mounted within the cassette case and fed along a specified second feed path within the cassette case. The double-sided adhesive tape has two surfaces. One of the two surfaces has a release material removably affixed thereto, and the other of the two surfaces is to be affixed to the printing tape. The tape feed roller has an outer circumferential surface and an axis extending in a vertical direction of the cassette case. The tape feed roller is supported by the cassette case, and is adapted to guide the double-sided adhesive tape along a section of the outer circumferential surface on the second feed path. A length of the section in a circumferential direction is equal to or longer than a quarter of a length of the outer circumferential surface in the circumferential direction. The laminated tape restricting member is provided on a downstream side of the tape feed roller on the first feed path and the second feed path, and at downstream ends of the first feed path and the second feed path where the first feed path and the second feed path overlap each other. The laminated tape restricting member includes a first member, a second member, a channel, and a tape discharge outlet. The first member that has a first face and the second member has a second face that is generally parallel to the first face. The second member is disposed to oppose the first member in a position that is farther from the tape feed roller than is the first member. The channel is formed between the first face of the first member and the second face of the second member. The first face and the second face are adapted to restrict a movement of a laminated tape in a direction that is perpendicular to surfaces of the laminated tape passing through the channel. An upstream edge of the second face in a feed direction of the laminated tape is located farther downstream than an upstream edge of the first face in the feed direction. The laminated tape is a tape formed by the printing tape and the double-sided adhesive tape affixed to the printing tape. The tape discharge outlet is located at a downstream end of the channel, and the laminated tape is discharged through the tape discharge outlet to an outside of the cassette case. The adhesive tape restricting member is disposed to oppose the section of the outer circumferential surface along which the double-sided adhesive tape is guided, and is disposed apart from the outer circumferential surface by a distance that is shorter than a length of the channel of the laminated tape restricting member. The adhesive tape restricting member is adapted to restrict a movement of the double-sided adhesive tape in a radially outward direction of the tape feed roller.

### BRIEF DESCRIPTION OF THE DRAWINGS

Exemplary embodiments of the present disclosure will be described below in detail with reference to the accompanying drawings in which:

FIG. 1 is a perspective view of a tape printer 1 in which a cassette cover 6 is closed;

FIG. 2 is a perspective view for explaining a tape cassette 30 and a cassette housing portion 8;

FIG. 3 is a block diagram that shows an electrical configuration of the tape printer 1;

FIG. 4 is a plan view of the cassette housing portion 8 in a case where the tape cassette 30 is installed and a platen holder 12 is in a standby position;

FIG. 5 is an enlarged plan view of an area around a tape feed roller 46 in a case where the tape cassette 30 is installed in the cassette housing portion 8 and the platen holder 12 is in a printing position;

FIG. 6 is an enlarged plan view of the area around the tape feed roller 46 of the tape cassette 30;

FIG. 7 is an enlarged plan view of the area around the tape feed roller 46 in a case where the tape cassette 30 is installed in the cassette housing portion 8, the platen holder 12 is in the standby position, and a laminated tape 50 is out of a tape channel 63 of the tape cassette 30;

FIG. 8 is a flowchart of a tape feed program;

FIG. 9 is a figure for explaining stages of processing that is performed when the tape feed program is executed;

FIG. 10 is a figure for explaining the stages of the processing that is performed when the tape feed program is executed; and

FIG. 11 is a figure for explaining the stages of the processing that is performed when the tape feed program is executed.

### DETAILED DESCRIPTION OF EXEMPLARY EMBODIMENTS

Hereinafter, an embodiment of the present invention will be explained with reference to the drawings. Note that the referenced drawings will be used in order to explain technological features that can be employed, and device configurations and the like that are described in the drawings are simply explanatory examples to which the present invention is in no way limited.

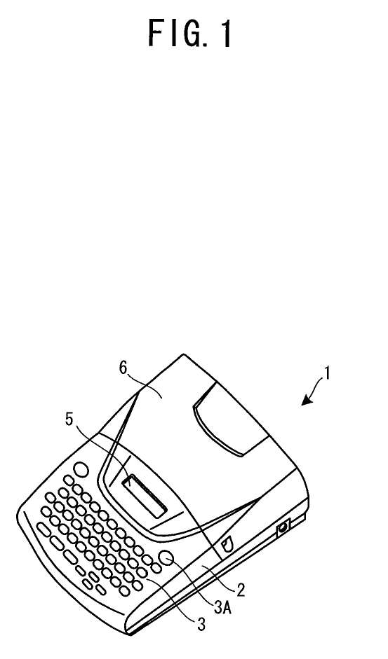

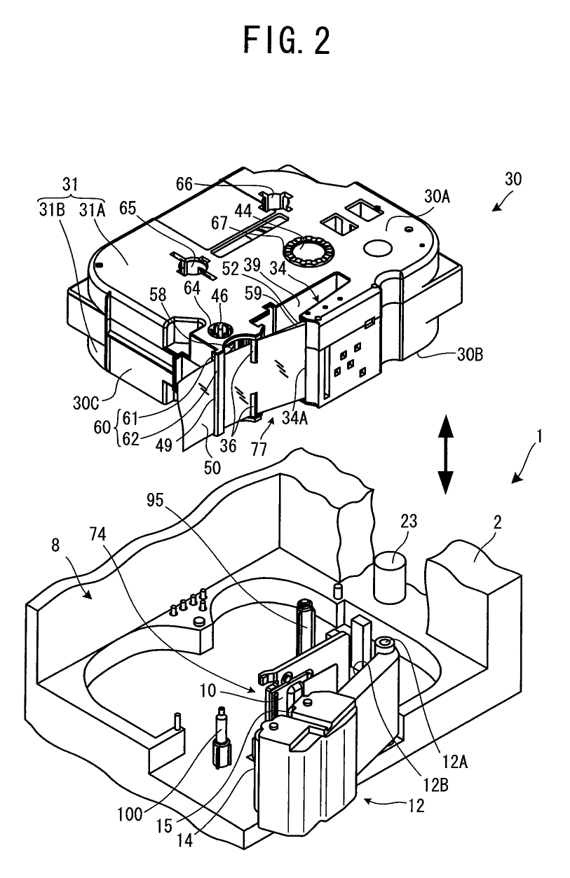

First, configurations of a tape printer 1 and a tape cassette 30 according to the present embodiment will be explained with reference to FIGS. 1 to 7. In the explanation of the present embodiment, the lower left side and the lower right side of FIG. 1 are the front face (the front surface) side and the right face side of the tape printer 1, respectively. Further, the upper side, the lower side, the lower right side and the upper right side of FIG. 2 is the upper side, the lower side, the front face (the front surface) side and the right face side of the tape cassette 30 and the tape printer 1.

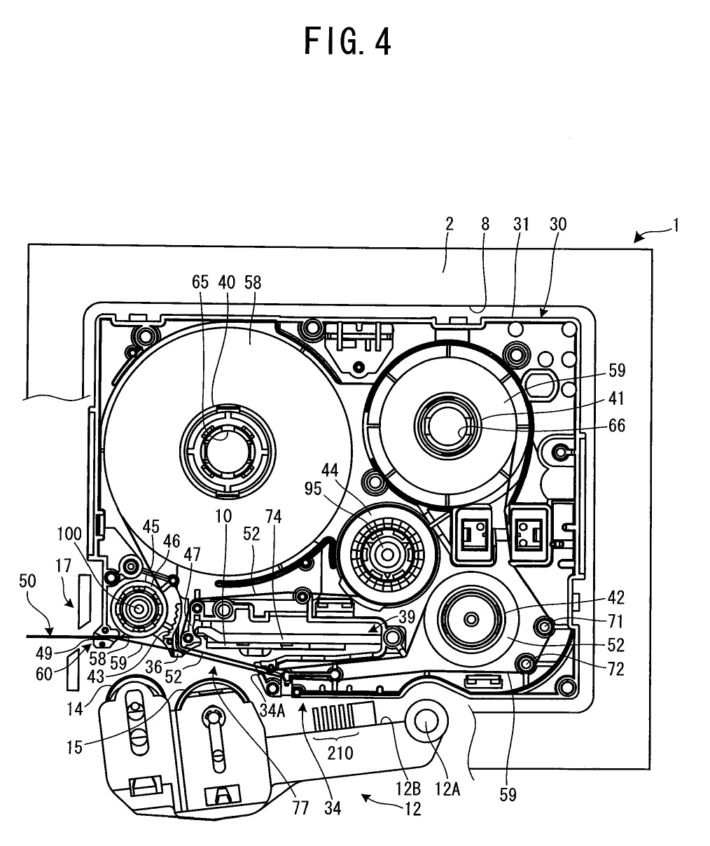

In the present embodiment, an example of a laminated type tape cassette will be explained in which a film tape 59 that is a transparent film, a double-side adhesive tape 58, and an ink ribbon 52 (refer to FIG. 4) are mounted. With the laminated type tape cassette 30, printing is performed on the film tape 59, and then the double-sided adhesive tape 58 is affixed to a printed surface of the film tape 59. Thus, the printed surface can be protected. The tape printer 1 is configured as a general-purpose device that can be used not only with the laminated type tape cassette 30, but also with another type of tape cassette. Examples of the other type of tape cassette 30 may include a thermal type tape cassette that contains only a heat-sensitive tape, a thermal laminated type tape cassette that contains a heat-sensitive tape, and a double-sided adhesive tape, and a receptor type tape cassette that contains a printing tape and an ink ribbon, and the like. In the present embodiment, the film tape 59 to which the double-sided adhesive tape 58 is affixed will be referred to as “a laminated tape 50”. In addition, the film tape 59, the double-sided adhesive tape 58, and the laminated tape 50 will be collectively referred to as “the tape” in some cases.

The external appearance of the tape printer 1 will be explained with reference to FIG. 1. The tape printer 1 includes a main body cover 2 that has a roughly rectangular shape in a plan view. The main cover 2 covers and protects an internal structure. A keyboard 3 that includes character keys for inputting characters, symbols, numerals, and the like, a power key 3A, and various types of function keys is provided on the top face side of the main body cover 2. To the rear of the keyboard 3, a display 5 is provided that can display input characters. To the rear of the display 5, a cassette cover 6 is provided that can be opened and closed when the tape cassette 30 (described later) is replaced, the axis of the opening and closing of the cassette cover 6 being on the rear face side of the tape printer 1. The cassette cover 6 is provided for a cassette housing portion 8 that is described below. In addition, a discharge slit for discharging the printed tape to the outside is provided on the left side face of the main body cover 2 and the cassette cover 6, although it is not shown in the drawings.

Next, the cassette housing portion 8 will be explained with reference to FIG. 2. The cassette housing portion 8 is a portion of the main body cover 2 that is formed as a recess. The cassette housing portion 8 is provided to the rear of the display 5. When the cassette cover 6 is closed, the cassette housing portion 8 is covered and protected by the cassette cover 6. As shown in FIG. 2, the cassette housing portion 8 has a recessed shape that matches the exterior shape of a box-shaped cassette case 31 that configures the exterior form of the tape cassette 30, such that the tape cassette 30 can be installed from above when the cassette cover 6 is open.

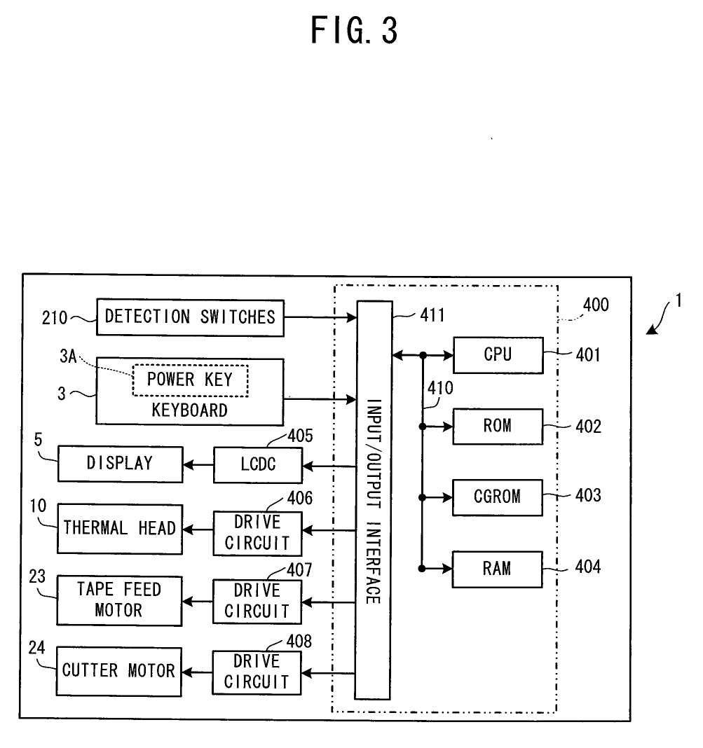

A feed mechanism, a printing mechanism, a cutting mechanism and the like are provided in the cassette housing portion 8. The feed mechanism pulls the tape from the tape cassette 30 and feeds the tape. The printing mechanism prints characters and the like on a surface of the tape. The cutting mechanism cuts off the tape. In the center of the front side of the cassette housing portion 8, a head holder 74 is provided. A thermal head 10 that includes a heating element (not shown in the drawings) is mounted on the head holder 74. A ribbon take-up shaft 95 that performs rotational driving of a ribbon take-up spool 44 (refer to FIG. 4) that will be described later is provided obliquely to the rear of the head holder 74. A tape drive shaft 100 that performs rotational driving of a tape feed roller 46 (refer to FIG. 4) that will be described later is provided to the left and slightly to the rear of the head holder 74. Further, on the outside of the cassette housing portion 8, a tape feed motor 23 is provided that rotationally drives the ribbon take-up shaft 95 and the tape drive shaft 100 by transmitting a driving force to them through a group of gears that are not shown in the drawings. On the outside of the cassette housing portion 8, in a position on the left side of the cassette housing portion 8 toward the front, a cutting mechanism 17 (refer to FIG. 4) is provided. The cutting mechanism 17 is driven by a cutter motor 24 (refer to FIG. 3) and that cuts off the tape that is discharged from a tape discharge outlet 49 of the tape cassette 30 that will be described later.

To the front of the head holder 74, an arm-shaped platen holder 12 is provided. The platen holder 12 is supported at one end by a shaft support portion 12A such that the platen holder 12 can swing horizontally. A plurality of detection switches 210 (refer to FIG. 4) are provided on a rear face of the platen holder 12, that is, on a face 12B that faces the thermal head 10. Each of the detection switches 210 projects rearward such that it faces a front face (more specifically, a front face of an arm portion 34 that will be described later) of the tape cassette 30 that is mounted in the cassette housing portion 8. Each of the detection switches 210 is in a protruding state to be off when it is not pressed, while it is in a retracted state to be on when it is pressed. Apertures are provided in the front face of the tape cassette 30 in a pattern that corresponds to a type of the tape. The detection switches 210 are selectively pressed when the tape cassette 30 is installed in the cassette housing portion 8. At this time, whether or not the tape cassette 30 is installed and the type of the tape can be detected based on a combination of the on and off states of the detection switches 210. If all of the detection switches 210 are in the off state, a state in which the tape cassette 30 is not installed can be detected.

Near a free end of the platen holder 12, a platen roller 15 is rotatably supported in a position that corresponds to the thermal head 10. At the free end of the platen holder 12, a movable feed roller 14 is rotatably supported in a position that corresponds to the tape feed roller 46 of the tape cassette 30. The tape feed roller 46 can be fitted with the tape drive shaft 100.

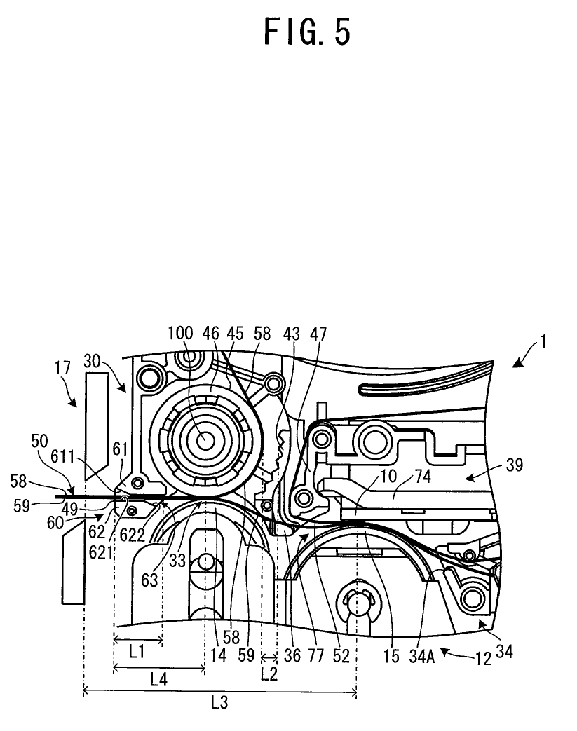

The free end of the platen holder 12 is configured such that the free end is swung by a mechanism that is not shown in the drawings in conjunction with the opening and closing of the cassette cover 6. Specifically, when the cassette cover 6 is closed, the free end of the platen holder 12 moves to a printing position within the cassette housing portion 8 (refer to FIG. 5). In the printing position, the platen roller 15 and the movable feed roller 14 are respectively pressed against the thermal head 10 and the tape feed roller 46 and printing can be performed. When the cassette cover 6 is opened, the free end of the platen holder 12 moves to a standby position outside the cassette housing portion 8 (refer to FIG. 4). In the standby position, the platen roller 15 and the movable feed roller 14 are respectively separated from the thermal head 10 and the tape feed roller 46 and the tape cassette 30 can be removed from the cassette housing portion 8.

Next, an electrical configuration of the tape printer 1 will be explained with reference to FIG. 3. As shown in FIG. 3, the tape printer 1 is provided with a control circuit portion 400 that is formed on a control board. The control circuit portion 400 includes a CPU 401 that controls various devices, as well as a ROM 402, a CGROM 403, a RAM 404, an input/output interface 411, and the like that are connected to the CPU 401 through a data bus 410.

Various types of programs for controlling the tape printer 1, including a tape feed program that will be described later, are stored in the ROM 402. The CPU 401 performs various types of computations in accordance with the various types of programs stored in the ROM 402. Various types of data and tables that may be referenced by the tape feed program are also stored in the ROM 402. Printing dot pattern data that may be used for the printing of characters are stored in the CGROM 403. The RAM 404 may be used in the executing of the various types of programs, and various types of data, flags, and the like are stored in the RAM 404.

The detection switches 210, the keyboard 3 that includes the power key 3A, a liquid crystal drive circuit (LCDC) 405, and drive circuits 406 to 408 and the like are connected to the input/output interface 411. The LCDC 405 has a video RAM (not shown in the drawings) for outputting display data to the display (LCD) 5. The drive circuits 406 to 408 drive the thermal head 10, the tape feed motor 23, and the cutter motor 24, respectively.

Next, the general configuration of the tape cassette 30 will be explained with reference to FIG. 2. The tape cassette 30 includes a box-shaped cassette case 31 that has a top face 30A, a bottom face 30B, and side faces 30C. In the present embodiment, the side faces 30C includes four side faces, that is, the front face, a rear face, a left side face, and a right side face. The double-sided adhesive tape 58, the film tape 59, and the ink ribbon 52 (refer to FIG. 4) are mounted within the cassette case 31. The cassette case 31 is formed by joining a top case 31A and a bottom case 31B in the vertical direction.

The entire peripheries of the top face 30A and the bottom face 30B may not always be surrounded by the side faces 30C. For example, a part of the side faces 30C (the rear face, for example) may include an aperture that exposes the interior of the cassette case 31 to the outside. Further, a boss that connects the top face 30A and the bottom face 30B may be provided in a position facing the aperture.

In the cassette case 31, support holes 65, 66, 67, and 64 are provided. Note that, only the support holes 65, 66, 67 and 64 in the top case 31A are shown in FIG. 2, but the corresponding support holes 65, 66, 67 and 64 are also provided in the bottom case 31B. The support holes 65, 66, 67, and 64 rotatably support, within the cassette case 31, a first tape spool 40, a second tape spool 41 (refer to FIG. 4), the ribbon take-up spool 44, and the tape feed roller 46, respectively. A head insertion portion 39, into which the head holder 74 is inserted, is provided on the front side of the cassette case 31. The head insertion portion 39 is a space that runs through the tape cassette 30 in the vertical direction. The head insertion portion 39 is open to the front side at a position to the left of the center of the front face of the cassette case 31. Hereinafter, the portion that extends to the left from the right front portion of the cassette case 31 will be referred to as the arm portion 34. The aforementioned open portion of the head insertion portion 39 to the left from the end of the arm portion 34 will be referred to as the open portion 77.

A slit-shaped exit 34A that extends in the vertical direction of the cassette case 31 is provided in the leading end of the arm portion 34. The film tape 59 and the ink ribbon 52 are directed within the arm portion 34 and discharged through the exit 34A toward the open portion 77. At the open portion 77, printing is performed on the discharged film tape 59 by the thermal head 10 using the ink ribbon 52. More specifically, when the platen holder 12 is in the printing position (refer to FIG. 5), the film tape 59 and the ink ribbon 52 are sandwiched between the platen roller 15 and the thermal head 10 at the open portion 77. In this state, when the printing is performed by the thermal head 10, the ink that is held by the ink ribbon 52 is transferred to the film tape 59.

On the front side of the cassette case 31, on the left side of the open portion 77 of the head insertion portion 39, a pair of restricting members 36 are provided at the top and the bottom. Each of the restricting members 36 includes a base portion that restricts the film tape 59 in the vertical direction (a tape width direction of the tape) and a projecting portion that prevents the film tape 59 from deviating to the front. A laminated tape restricting member 60 is provided at the left end of the front side of the cassette case 31. The laminated tape restricting member 60 has the tape discharge outlet 49 through which the laminated tape 50 is discharged from the tape cassette 30. The laminated tape 50 that is discharged through the tape discharge outlet 49 passes between two blades of the cutting mechanism 17 that is provided on the outside of the cassette housing portion 8, is cut, is guided to the discharge slit that is not shown in the drawings, and is discharged to the outside of the tape printer 1.

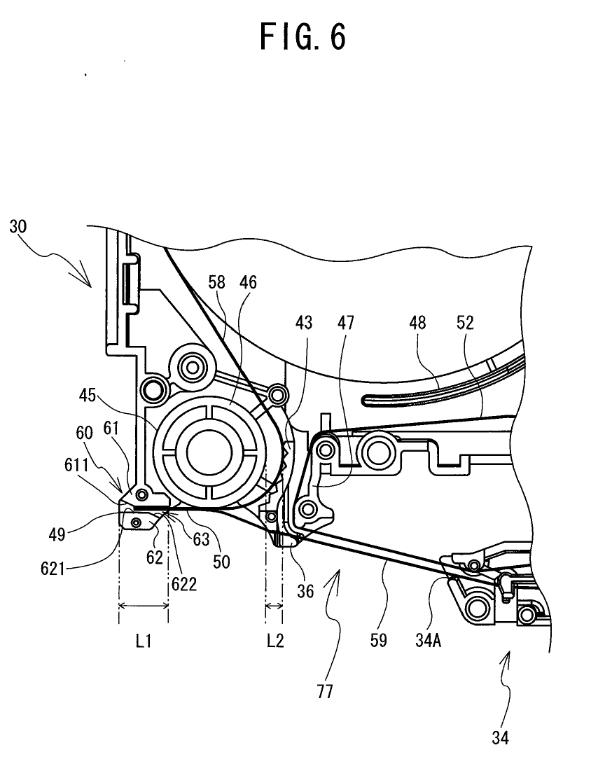

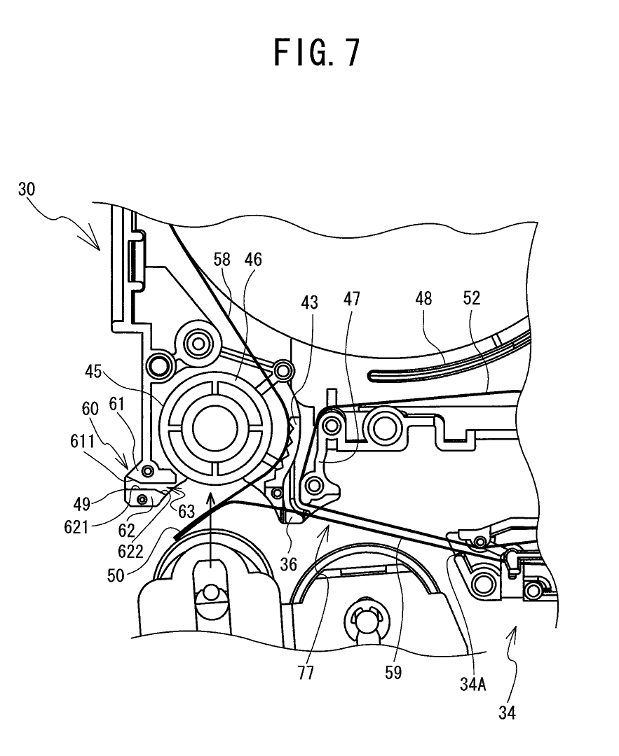

Next, the internal structure of the tape cassette 30 will be explained with reference to FIGS. 4 and 5. Note that in order to make the explanation easier, FIGS. 4 and 5 show a state in which the tape cassette 30 is mounted in the cassette housing portion 8 with the top case 31A removed (the same applies to FIGS. 6 and 7). The first tape spool 40 is disposed toward the left rear within the cassette case 31 and is rotatably supported with the support holes 65 as its axis. The double-sided adhesive tape 58 has a release paper on one surface, and it is wound on the first tape spool 40 such that the release paper faces the outside. The second tape spool 41, on which the film tape 59 is wound, is disposed toward the right rear within the cassette case 31 and is rotatably supported with the support holes 66 as its axis. A ribbon spool 42, on which the ink ribbon 52 is wound, is disposed toward the right front within the cassette case 31 and is rotatably supported.

Between the first tape spool 40 and the ribbon spool 42, the ribbon take-up spool 44 is rotatably supported with the support holes 67 of the top case 31A and the bottom case 31B as its axis. The ribbon take-up spool 44 is rotationally driven by the ribbon take-up shaft 95. The ribbon take-up spool 44 pulls the ink ribbon 52 from the ribbon spool 42 and takes up the ink ribbon that has been used for printing characters. A clutch spring (not shown in the drawings) is attached to a lower portion of the ribbon take-up spool 44 to prevent loosening of the taken up ink ribbon 52 due to a reverse rotation of the ribbon take-up spool 44.

Cylindrical guide members 71, 72 are respectively provided to the right and the right front from the ribbon spool 42. The guide member s 71, 72 guides the film tape 59 pulled from the second tape spool 41 towards the inside of the arm portion 34.

A guide wall 47 is provided on the left side of the head insertion portion 39 and to the rear of the restricting members 36. The guide wall 47 separates the used ink ribbon 52 from the film tape 59 guided to the restricting members 36, and guides the ink ribbon 52 toward the ribbon take-up spool 44. The ink ribbon 52 that is pulled from the ribbon spool 42 by the rotational driving of the ribbon take-up spool 44 is used for printing by the thermal head 10, is guided by the guide wall 47, and is wound onto the ribbon take-up spool 44.

The cylindrical tape feed roller 46 is disposed in front of the first tape spool 40 and is rotatably supported by the support holes 64 (refer to FIG. 2) with its axis in the vertical direction. In the state in which the tape cassette 30 has been mounted in the tape printer 1 and the free end of the platen holder 12 has moved to the printing position (refer to FIG. 5), the tape feed roller 46 faces the movable feed roller 14 that is provided on the free end side of the platen holder 12. The tape feed roller 46 guides the double-sided adhesive tape 58 along a right front portion of its outer circumferential surface 45 toward the laminated tape restricting member 60 that will be described later.

When the platen holder 12 is in the printing position, the tape feed roller 46 and the movable feed roller 14 are in a mutually pressing state. A portion between the tape feed roller 46 and the movable feed roller 14 at this time will be hereinafter referred to as a nip portion 33 (refer to FIG. 5). In the nip portion 33, the tape feed roller 46 and the movable feed roller 14 pinch the double-sided adhesive tape 58 and the film tape 59 together therebetween, and affix the tapes together to form the laminated tape 50. The tape feed roller 46 then operates in conjunction with the movable feed roller 14 to feed the laminated tape 50 pinched at the nip portion 33 toward the laminated tape restricting member 60. The double-sided adhesive tape 58 is pulled from the first tape spool 40 and the film tape 59 is pulled from the second tape spool 41 by the joint operation of the tape feed roller 46 and the movable feed roller 14.

A restricting wall 43 extends from the right side of the tape feed roller 46 to the right front side of the tape feed roller 46. The restricting wall 43 is adapted to restrict a movement of the double-sided adhesive tape 58 in a radially outward direction of the tape feed roller 46. In a plan view, the restricting wall 43 is formed into an arc shape that matches the outer circumferential surface 45 of the tape feed roller 46. The restricting wall 43 is disposed apart from the outer circumferential surface 45 and facing the section of the outer circumferential surface 45 along which the double-sided adhesive tape 58 is guided. Furthermore, a surface of the side of the restricting wall 43 that faces the outer circumferential surface 45 is formed into a series of steps in the circumferential direction (a sawtooth shape in the plan view). The surface of the restricting wall 43 that has the series of steps faces the surface of the double-sided adhesive tape 58 that is not covered by the release paper. Even if the double-sided adhesive tape 58 comes into contact with the restricting wall 43 having the series of steps, the double-sided adhesive tape 58 can be easily peeled off, because the surface area of contact is small.

The laminated tape restricting member 60 is provided to the left front of the tape feed roller 46. The laminated tape restricting member 60 is adapted to restrict a movement of the laminated tape 50 in a thickness direction of the laminated tape 50, that is, in a direction perpendicular to the surfaces of the laminated tape 50 (in the front-rear direction of the cassette case 31) and discharge the laminated tape 50 to the outside of the tape cassette 30 through the tape discharge outlet 49.

The detailed structure of the laminated tape restricting member 60 will be explained with reference to FIG. 5. The laminated tape restricting member 60 includes a first member 61 and a second member 62 that are opposing each other such that they sandwich the film tape 59 in the thickness direction. Each of the first member 61 and the second member 62 is a columnar member that extends in the vertical direction of the cassette case 31 and that is generally rectangular in a plan view. The first member 61 is disposed to the rear side, while the second member 62 is disposed to the front side. In other words, the second member 62 is disposed farther from the tape feed roller 46 than is the first member 61.

A first face 611, which is the front face of the first member 61, faces the second member 62. The first face 611 faces the surface of the laminated tape 50 on the double-sided adhesive tape 58 side, and restricts the movement of the laminated tape 50, of directions that are perpendicular to the surfaces of the laminated tape 50, in a direction toward the double-sided adhesive tape 58 side (toward the rear of the cassette case 31). The first face 611 includes an inclined face at its downstream end in relation to the feed direction of the laminated tape 50. The inclined face inclines away from the laminated tape 50 from an upstream side toward a downstream side.

A second face 621, which is the rear face of the second member 62, faces the first member 61. The second face 621 faces the surface of the laminated tape 50 on the film tape 59 side, and restricts the movement of the laminated tape 50, of the directions that are perpendicular to the surfaces of the laminated tape 50, in a direction toward the film tape 59 side (toward the front of the cassette case 31). The second face 621 is generally parallel to the first face 611. The second face 621 includes an inclined face 622 at its upstream end in relation to the feed direction of the laminated tape 50. The inclined face 622 inclines away from the laminated tape 50 from a downstream side toward an upstream side. An upstream edge of the second face 621 is located farther downstream in the feed direction than an upstream edge of the first face 611. In other words, a length of the second member 62 along the feed direction of the laminated tape 50 is shorter than a length of the first member 61 along the feed direction of the laminated tape 50.

Between the first face 611 of the first member 61 and the second face 621 of the second member 62, a tape channel 63, through which the laminated tape 50 is fed, is formed along a right- left direction of the tape cassette 30. The tape channel 63 includes the tape discharge outlet 49 at a downstream end (a left end in FIG. 5) in relation to the feed direction of the laminated tape 50. The laminated tape 50 can be discharged outside through the tape discharge outlet 49. A position of the tape channel 63 in relation to the front-rear direction of the tape cassette 30 is the same as a position of the front end of the tape feed roller 46. If a length of the tape channel 63 in the feed direction of the laminated tape 50 is defined as L1, and a distance between the restricting wall 43 and the outer circumferential surface 45 of the tape feed roller 46 is defined as L2, the length L1 is longer than the distance L2 (L1>L2).

Next, feed paths of the double-sided adhesive tape 58, the film tape 59, and the laminated tape 50 inside the tape cassette 30 will be explained with reference to FIG. 4.

The feed path of the film tape 59 will be explained. The film tape 59 wound on the second tape spool 41 in a clockwise direction is pulled forward at the right side of the second tape spool 41, and fed to the right front portion of the tape cassette 30. Then, the film tape 59 is bent toward the left by the guide members 71, 72 and reaches the arm portion 34. The film tape 59 is fed toward the left in the arm portion 34 and discharged through the exit 34A formed at the left end of the arm portion 34 toward the open portion 77. The discharged film tape 59 is further fed leftwards, the movement of the film tape 59 in the vertical direction (the tape width direction) is restricted by the base portions of the restricting members 36, and the film tape 59 is directed toward the front of the tape feed roller 46.

The feed path of the double-sided adhesive tape 58 will be explained. The double-sided adhesive tape 58 wound on the first tape spool 40 in a counterclockwise direction is pulled forward at the left side of the first tape spool 40. The double-sided adhesive tape 58 that has been pulled to the front of the tape cassette 30 is bent toward the left at the right front portion of the tape feed roller 46 along the outer circumferential surface 45. A length in a circumferential direction of a section of the outer circumferential surface 45 that contacts the double-sided adhesive tape 58 is equal to or longer than a quarter (¼) of a length of the entire circumference of the outer circumferential surface 45. The double-sided adhesive tape 50 that has been fed from the rear to the front, that is, from the first tape spool 40 to the tape feed roller 46, is bent at a sharp angle along the right front portion of the outer circumference surface 45 of the tape feed roller 46 and fed toward the left (to the front of the tape feed roller 46).

At the front end of the tape feed roller 46 (the nip portion 33), the film tape 59 and the double-sided adhesive tape 58 are pinched and affixed together by the tape feed roller 46 and the movable feed roller 14. Thus, the laminated tape 50 is formed from the film tape 59 and the double-sided adhesive tape 58.

The feed path of the laminated tape 50 will be explained. The laminated tape 50 is formed by the film tape 59 and the double-sided adhesive tape 58 affixed together. Therefore, the feed path of the laminated tape 50 is formed at the downstream end portions of the feed paths of these tapes where the feed path of the double-sided adhesive tape 58 and the feed path of the film tape 59 converge and overlap each other. The laminated tape 50 formed at the nip portion 33 is fed leftwards by the joint operation of the tape feed roller 46 and the movable feed roller 14 toward an inlet of the tape channel 63 of the laminated tape restricting member 60. The laminated tape 50 passes through the tape channel 63 and is discharged through the tape discharge outlet 49 to the outside of the tape cassette 30.

In the tape cassette 30 that has the structure as described above, in a state where the tape cassette 30 is not installed in the tape printer 1 such as when the tape cassette 30 is shipped out or the laminated tape 50 has been cut off, the film tape 59 is exposed to the outside over a section from the exit 34A to the front of the tape feed roller 46, as shown in FIG. 2. In addition, the laminated tape 50 is exposed to the outside from the front of the tape feed roller 46 to the inlet of the tape channel 63, and also on the downstream side of the tape discharge outlet 49 in relation to the feed direction. Therefore, when the tape cassette 30 is removed, when it is stored, when the tape printer 1 is not in use with the power supply being off, for example, the film tape 59 or the laminated tape 50 may be subject to an external force such as the user's touch, for example.

Movements of the respective tapes when the laminated tape 50 or the film tape 59 is pushed upstream in the feed direction upon receiving the external force will be explained with reference to FIG. 6. If the film tape 59 or the laminated tape 50 is pushed upstream in relation to the feed direction, the double-sided adhesive tape 58 that is affixed to the film tape 59 is also pushed upstream in relation to the feed direction along with the film tape 59.

On the upstream side of the nip portion 33 in relation to the feed direction, the double-sided adhesive tape 58 is separated from the film tape 59 and is fed along the different feed path. Therefore, if the double-sided adhesive tape 58 is pushed upstream in relation to the feed direction, on the upstream side of the nip portion 33, independently of the film tape 59, the section of the double-sided adhesive tape 58 that was in contact with the outer circumferential surface 45 of the tape feed roller 46 (refer to FIG. 5) separates from the outer circumferential surface 45 and bends in the radially outward direction of the tape feed roller 46. The bending double-sided adhesive tape 58 strikes the restricting wall 43, which is disposed apart from the outer circumferential surface 45 in the radially outward direction of the outer circumferential surface 45. The movement in the direction of the restricting wall 43 of the double-sided adhesive tape 58 that has struck the restricting wall 43 is restricted, so the double-sided adhesive tape 58 is not pushed farther upstream in relation to the feed direction.

In this case, from the state in which the double-sided adhesive tape 58 is in contact with the outer circumferential surface 45 to the state where the double-sided adhesive tape 58 strikes the restricting wall 43, a length of the double-sided adhesive tape 58 that is pushed upstream in relation to the feed direction is almost the same as the distance L2 between the outer circumferential surface 45 and the restricting wall 43. Accordingly, the maximum value for the length of the double-sided adhesive tape 58 that can be pushed upstream in relation to the feed direction is almost equal to the distance L2. To put it another way, the length of the double-sided adhesive tape 58 that can be pushed upstream in relation to the feed direction is not greater than the distance L2. Because the double-sided adhesive tape 58 is affixed to the film tape 59 at the nip portion 33, the length of the film tape 59 that can be pushed upstream in relation to the feed direction is equal to the length of the double-sided adhesive tape 58 that can be pushed upstream in relation to the feed direction, that is, not greater than the distance L2.

As described above, the length L1 of the tape channel 63 is longer than the distance L2 (L1>L2). Therefore, even in a case where the laminated tape 50 is pushed upstream in relation to the feed direction, usually the leading end of the laminated tape 50 (the end on the downstream side in relation to the feed direction) does not move farther upstream in relation to the feed direction than the inlet of the tape channel 63 (the end on the upstream side in relation to the feed direction). Thus, because the length L1 is made greater than the distance L2, it may be possible to prevent the laminated tape 50 from coming out of the tape channel 63.

The movements of the respective tapes when the tape cassette 30 in which the double-sided adhesive tape 58 is in contact with the restricting wall 43 is installed in the cassette housing portion 8 and the tape printer 1 starts printing operations will be explained with reference to FIGS. 5 and 6.

The movement of the laminated tape 50 will be explained. As shown in FIG. 6, at least the downstream end of the laminated tape 50 is within the tape channel 63. If the printing operations are started in this state, the tape feed roller 46 and the movable feed roller 14 (refer to FIG. 5) pinch the double-sided adhesive tape 58 and the film tape 59 to form the laminated tape 50, and feed it leftwards. Therefore, the laminated tape 50 is fed through the tape channel 63 to the left, while its movements in the direction perpendicular to its surfaces is restricted. The laminated tape 50 is then discharged through the discharge outlet 49 to the outside of the tape cassette 30. Thus, the laminated tape 50 can go back to the feed path.

The movement of the double-sided adhesive tape 58 will be explained. The double-sided adhesive tape 58 is affixed to the film tape 59 by the tape feed roller 46 and the movable feed roller 14. The laminated tape 50 thus formed is fed leftwards. First, the bending portion is fed and affixed to the film tape 59. When the length of the tape that has been fed becomes equal to or longer than the length that has been pushed upstream, there is no more bending portion. Therefore, the double-sided adhesive tape 58, which has been in contact with the restricting wall 43 as shown in FIG. 6, comes into contact with the outer circumferential surface 45 again as shown in FIG. 5. Thus, the double-sided adhesive tape 58 can go back to the feed path.

When the double-sided adhesive tape 58 is bending, the portion of the double-sided adhesive tape 58 that is in contact with the restricting wall 43 adheres to the restricting wall 43. However, because the surface of the side of the restricting wall 43 that faces the outer circumferential surface 45 is formed into the series of steps, an area of contact between the double-sided adhesive tape 58 and the restricting wall 43 is small and so the adhesion force is small. Therefore, as the double-sided adhesive tape 58 is fed, the double-sided adhesive tape 58 may easily come off from the restricting wall 43. Thus, even though the double-sided adhesive tape 58 partly adheres to the restricting wall 43, it does not affect feeding of the double-sided adhesive tape 58.

As for the film tape 59, similarly, when the length of the film tape 59 that has been fed by the tape feed roller 46 and the movable feed roller 14 becomes equal to or longer than the length that has been pushed upstream, there is no more bending portion. Then, the film tape 59 can go back to the feed path.

In a case where the external force is greater than the resilience of the double-sided adhesive tape 58, the double-sided adhesive tape 58 may bend further after it strikes the restricting wall 43. In such a case, the laminated tape 50 may come out of the tape channel 63. The movement of the laminated tape in this case will be explained with reference to FIG. 7.

As described above, in the laminated tape restricting member 60, the upstream edge of the first face 611 is positioned farther upstream in relation to the tape feed direction than is the upstream edge of the second face 621. Consequently, it may be possible to restrict the movement of the leading end of the laminated tape 50 in the direction toward the tape feed roller 46 (toward the inside of the cassette case 31), even in a case where the leading end of the laminated tape 50 comes out of the tape channel 63. In addition, it may be possible to prevent the laminated tape 50 going inside in the direction toward the tape feed roller 46.

If the leading end of the laminated tape 50 goes inside the tape cassette 30 toward the tape feed roller 46, the user may have difficulty in pulling out the laminated tape 50 from the interior of the cassette case 31 and putting it back to the proper feed path. On the other hand, if the leading end of the laminated tape 50 has come out toward the outside direction of the cassette case 31, as shown in FIG. 7, the user can put the laminated tape 50 back to the proper feed path simply by inserting the laminated tape 50 into the tape channel 63.

Alternatively, the laminated tape 50 can go back to the proper feed path in the following manner. When the cassette cover 6 of the tape printer 1 is closed, the platen holder 12 moves toward the tape cassette 30. Then, as shown in FIG. 7, the movable feed roller 14 provided on the free end side of the platen holder 12 contacts the laminated tape 50 that extends outside the tape cassette 30, and pushes the laminated tape 50 back toward the tape cassette 30 (tape feed roller 46). The movable feed roller 14 presses the tape feed roller 46 via the laminated tape 50. Then, the movable feed roller 14 and the tape feed roller 46 together feed the laminated tape 50 toward the inlet of the tape channel 63. Thus, the laminated tape 50 may be able to go back to the feed path easily.

As described above, the second face 621 of the second member 62 that faces the laminated tape 50 includes the inclined face 622 at its upstream end in relation to the feed direction of the laminated tape 50. The inclined face 622 inclines away from the laminated tape 50 (from rear to front) from the downstream side toward the upstream side. Therefore, even if the leading end of the laminated tape 50 is positioned farther to the front than the proper feed path on the upstream side of the inlet of the tape channel 63 in relation to the feed direction, the inclined face 622 may be able to guide the laminated tape 50 to the tape channel 63.

Next, an overview of the printing operation by the tape printer 1 will be explained. In a known tape printer, in a case where a length that is set as a leading margin is shorter than a length between a cutting position of the tape and a printhead (hereinafter referred to as a head-to-cutter distance), a total of the length of the leading margin and the length of a portion that is cut off as an unneeded portion on a leading side of the leading margin is always equal to the head-to-cutter distance. In other words, in a case where the length of the set leading margin is shorter than the head-to-cutter distance, a length of the tape that is equal to the head-to-cutter distance is always consumed on the leading side from a printing area in a single round of printing, regardless of the leading margin setting. The portion that is cut off as the unneeded portion is a portion that is consumed to no purpose, being used neither as the printing area not as the leading margin, so it would be desirable to reduce the amount of the tape that is consumed. Therefore, the tape printer 1 of the present invention is configured such that the tape printer 1 can perform processing to make the length of the portion of the tape that is always consumed on the leading side from the printing area in a single round of printing to be shorter than the head-to-cutter distance.

In the following explanation, in the feed direction of the laminated tape 50, a length (head-to-cutter distance) from a printing position where the thermal head 10 prints on the film tape 59 to a cutting position where the laminated tape 50 is cut off by the cutting mechanism 17 is defined as L3. In the present embodiment, the length L3 may be 25 millimeters (mm) Note that in addition to the physical distance between the printing position and the cutting position, the length L3 may also include distances that may be necessary during printing, such as distances that the tape feed motor 23 must slew up and slew down and the like.

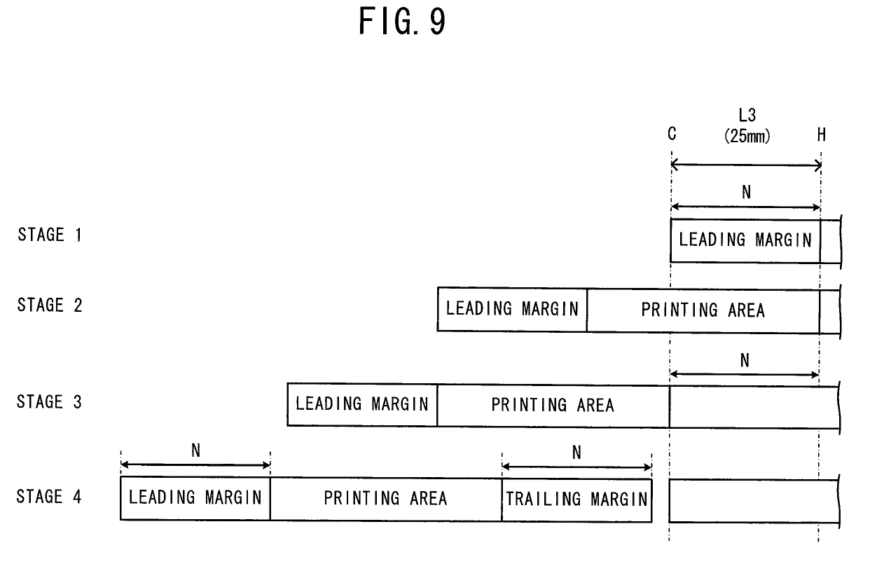

When the printing on the tape is performed by the tape printer 1, the user can set in advance, in relation to a printing area (the part of the tape on which the printing will be performed; refer to FIG. 9), a desired length N (millimeters; mm) for a leading margin (a margin on the leading side in relation to the printing area). The setting of the length N can be accomplished by an operation of the keyboard 3, and the length N is stored in the RAM 404. When the length N has not been set by the user, a value of 25 millimeters that is equivalent to the length L3 is read as a default value from the ROM 402 and is set as the length N. In the present embodiment, in a case where the user has set the length N for the leading margin to a value that is less than 25 millimeters (less than the length L3), the printing will be performed with the length N for the leading margin set to 25 millimeters, in order to make the explanation easier.

In the tape printer 1, the user can also freely decide whether or not to conserve on an amount of the tape to be consumed in a single round of the printing. A mode (an economy mode) in which the tape is conserved is set by default. If the user makes a setting for a mode (a normal mode) in which the tape is not conserved, a flag is stored in the RAM 404 that indicates that the current mode is the normal mode. In the economy mode, the length N of the leading margin is shortened by a tape conservation amount α (millimeters), and the printing is performed on the tape.

The tape conservation amount α may be set in accordance with the structure of the tape printer 1, using as a reference one of the length L1 of the tape channel 63 of the laminated tape restricting member 60, the distance L2 between the restricting wall 43 and the outer circumferential surface 45 of the tape feed roller 46, and a length L4 between the nip portion 33 and the tape discharge outlet 49, all of which are shown in FIG. 5. The greater-than and less-than relationships among the length L1, the distance L2, and the length L4 may vary according to the design of the tape printer 1. Thus, for example, the shortest one of L1, L2, and L4 may be used as the reference length for the tape conservation amount α, and the tape conservation amount α itself may be set to a length that is shorter than the reference length (a length that is not longer than the reference length).

The reason for setting the tape conservation amount α to a length that does not exceed the reference length is to reliably prevent a problem that may occur in a case where the tape feed motor 23 is driven in reverse. For example, a problem where the leading end of the laminated tape 50 comes out of the tape channel 63 or the nip portion 33 and cannot go back to the proper feed path, as well as a problem where the double-sided adhesive tape 58 strikes and adheres to the restricting wall 43, causing a jam can be prevented. Furthermore, in order to obtain the tape conservation amount α as long as possible, it is desirable to make the tape conservation amount α close to the reference length.

The tape printer 1 according to the present embodiment is designed such that the distance L2 is the shortest among L1, L2, and L4. Therefore, the distance L2 serves as the reference length, and a length (for example, 2.5 millimeters) that is shorter than the distance L2 is set as the tape conservation amount α and stored in the ROM 402. Therefore, in the economy mode, if the length N of the leading margin that the user has set is less than L3 (25 millimeters), the length of the part of the tape that is consumed toward the leading end from the printing area becomes 22.5 millimeters in each round of the printing, which conserves 2.5 millimeters compared to the length that is consumed in the normal mode.

In the tape printer 1, in a case where the power supply has just been turned on, as well as where the tape cassette 30 has just been installed or removed, the conserving of the amount of the tape to be consumed is not performed, even if the economy mode has been set. After the power supply has been turned on, after the tape cassette 30 has been replaced, or the like, the leading end of the tape is not necessarily at the cutting position of the cutting mechanism 17. More specifically, there may be cases in which the leading end of the tape has been subject to an external force and has been pushed upstream in relation to the tape feed direction, as described above. In a case where this sort of state has arisen, not performing the conserving of the amount of the tape to be consumed can reliably prevent the leading end of the laminated tape 50 from coming out of the tape channel 63 or the nip portion 33, and also prevent the double-sided adhesive tape 58 from coming into contact with the restricting wall 43.

In order to perform processing that does not perform the conserving of the amount of the tape to be consumed, in the tape printer 1, when the power supply is turned on by an operation of the power key 3A of the keyboard 3, and the power that is supplied to the tape printer 1 changes from the off state to the on state, a flag that indicates that the power supply is on is stored in an on state in the RAM 404. In the same manner, when the tape cassette 30 is installed or removed, such that a change occurs in the on and off states of the detection switches 210, a flag that indicates that the tape cassette 30 has been installed or removed is stored in an on state in the RAM 404. By referring to the flags, the CPU 401 determines in the processing according to the tape feed program that will be described later whether or not to perform the conserving of the amount of the tape to be consumed.

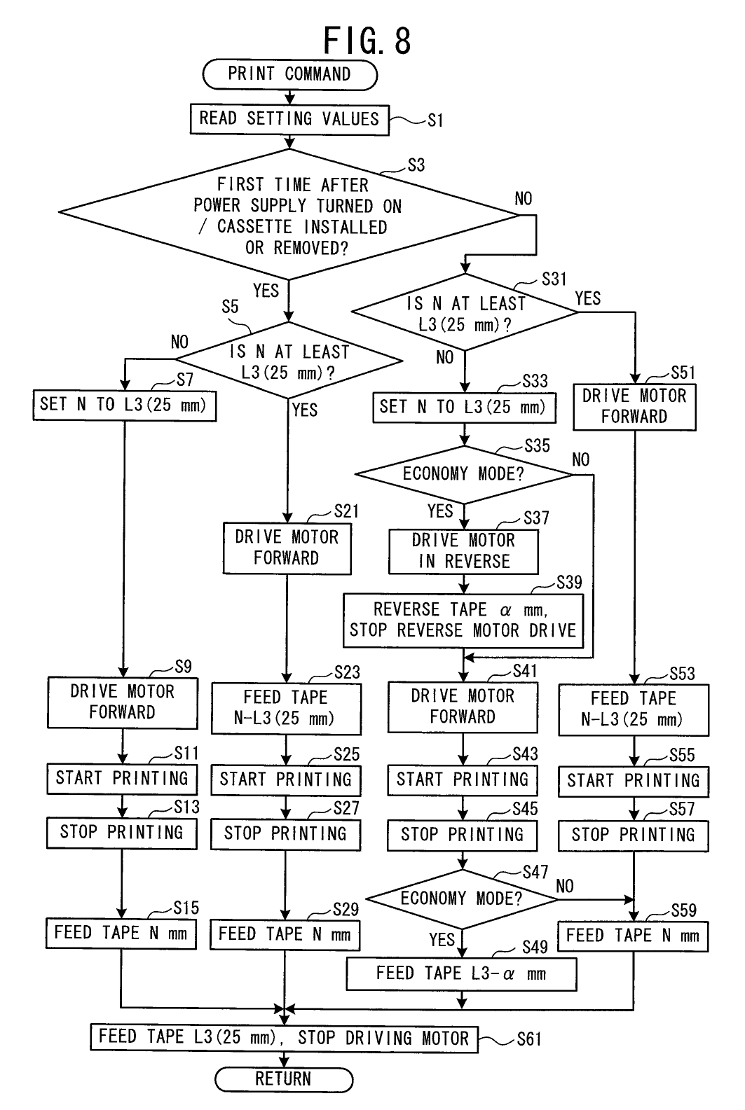

Hereinafter, concrete examples of the operation of the tape printer 1 during printing will be explained with reference to FIGS. 8 to 11. In the present embodiment, the tape feed program that causes the CPU 401 to perform the processing shown in FIG. 8 is a program that is called as a subroutine from a main program of the tape printer 1, and it governs processing that pertains to the feeding of the tape and the like. The configuration of the program in this form is obviously only one example, and the program may also be, for example, an independent program or a program that performs processing in parallel with other programs.

The CPU 401 executes the processing shown in FIG. 8 according to the tape feed program when it receives a command to print on the tape. As shown in FIG. 8, first, reading of the setting values from the RAM 404 is performed (Step S1), and the length N of the leading margin, the tape conservation amount α, the current mode, the states of the various types of flags, and the like are read. The state of the flag that indicates whether the power supply is on and the state of the flag that indicates whether the tape cassette 30 has been installed or removed are checked. If at least one of the flags is in the on state (YES at Step S3), it is assumed that the printing on the tape will be performed for the first time after one of the turning on of the power supply and the installation or removal of the tape cassette 30, so the CPU 401 proceeds to Step S5. Regardless of which mode is set, in the case where the conserving of the amount of the tape to be consumed is not performed, the feeding of the tape is performed by the processing at Steps S5 to S29.

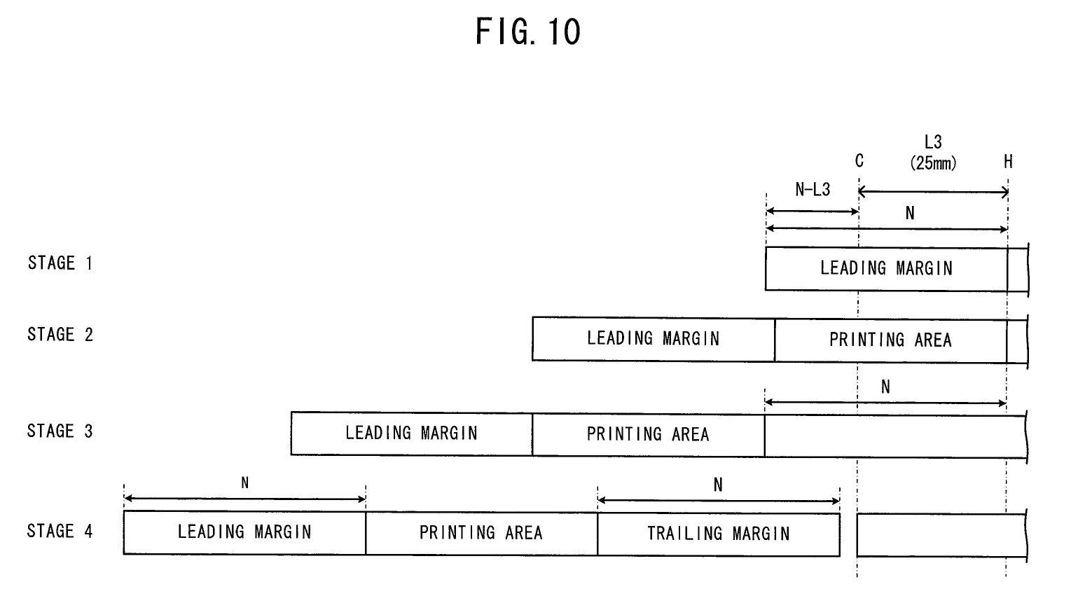

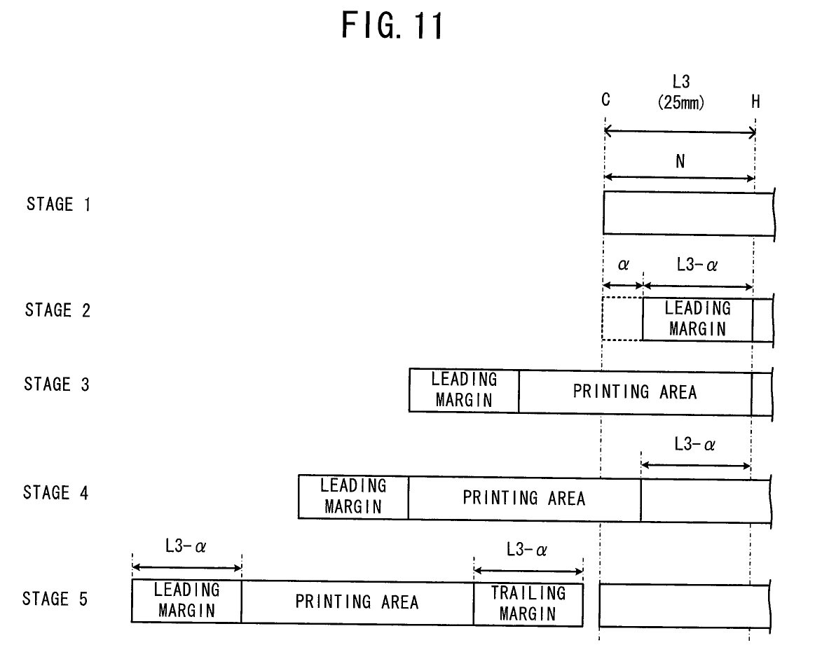

At Step S5, the CPU 401 checks whether the length that has been set as the length N of the leading margin is at least L3 (25 millimeters). In a case where the length is less than L3, the processing of Steps S7 to S15 are performed, while in a case where the length is at least L3, the processing of Steps S21 to S29 are performed. First, in a case where a length that is less than L3 has been set as the length N (NO at Step S5), the length N is overwritten and reset to L3 (25 millimeters) (Step S7). A concrete example of the processing at Steps S7 to S15 is shown in FIG. 9. In FIG. 9, the cutting position of the cutting mechanism 17 is indicated by C, and the printing position of the thermal head 10 is indicated by H. In addition, the right-to-left direction is the feed direction, and the left is the downstream side in relation to the feed direction. The feed states of the tape at each stage of the tape feeding are indicated using C and H as reference points. (The same is true in FIGS. 10 and 11.) At Step S7, as shown at stage 1 in FIG. 9, 25 millimeters that corresponds to the length L3 between the thermal head 10 and the cutting mechanism 17 is set as the length N of the leading margin.

As shown in FIG. 8, the tape feed motor 23 is driven forward (Step S9), and the printing in the printing area is started (Step S11). The details of the printing process are known, so an explanation will be omitted. The printing is performed as the tape is fed, and when the tape has been fed by the length of the printing area that is set according to the printing data, the printing is stopped (Step S13). The feed state of the tape at this time is shown at stage 2 in FIG. 9. The driving of the tape feed motor 23 is continued, and the tape is fed by the length N in order to ensure a trailing margin of the same length as the length N of the leading margin as a margin on the trailing side of the printing area (Step S15). The feed state of the tape at this time is shown at stage 3 in FIG. 9.

The processing proceeds to Step S61, and the tape feed motor 23 continues to be driven, and after the tape has been fed an additional 25 millimeters (L3), the driving of the tape feed motor 23 is stopped (Step S61), and the CPU 401 returns to the processing according to the main program. In this state, the cutting mechanism 17 is driven according to another program, and when the tape is cut off, a tape with a good appearance can be created that has a leading margin of the length N on the leading side of the printing area and has a trailing margin of the length N on the trailing side, as indicated by stage 4 in FIG. 9.

At Step S5, in a case where the length that has been set as the length N of the leading margin is at least L3 (25 millimeters) (YES at Step S5), the CPU 401 advances to Step S21, where the tape feed motor 23 is driven forward (Step S21). A concrete example of the processing at Steps S21 to S29 is shown in FIG. 10. When the tape is fed due to the driving of the tape feed motor 23 by a distance that is equal to N minus L3 (N−L3), the leading edge of the printing area reaches the position of the thermal head 10 (Step S23). The feed state of the tape at this time is shown at stage 1 in FIG. 10. In the same manner as described above, the printing is performed as the tape is fed (Step S25). When the tape has been fed by the length of the printing area that is set according to the printing data, the printing is stopped (Step S27). The feed state of the tape at this time is shown at stage 2 in FIG. 10.

The driving of the tape feed motor 23 is continued, and the tape is fed by the length N in order to ensure the trailing margin (Step S29). The feed state of the tape at this time is shown at stage 3 in FIG. 10. The processing proceeds to Step S61, after the tape has been fed by the additional length L3, the driving of the tape feed motor 23 is stopped (Step S61). The CPU 401 returns to the processing according to the main program. When the tape is cut off by the cutting mechanism 17, a tape with a good appearance is created in which a leading margin that has the length N that is at least L3 has been formed on the leading side of the printing area and a trailing margin that has the length N that is at least L3 has been formed in the same manner on the trailing side, as indicated at stage 4 in FIG. 10.

At Step S3, if the state of the flag that indicates whether the power supply is on and the state of the flag that indicates whether the tape cassette 30 has been installed or removed are both in the off state (NO at Step S3), it is assumed that the current round of the printing on the tape is printing processing that will be performed for at least the second time after the turning on of the power, and that the tape cassette 30 has not been removed or installed between the previous round and the current round of the printing processing, so the CPU 401 proceeds to Step S31. In a case where the conserving of the amount of the tape to be consumed will be performed in accordance with the setting of the mode, the feeding of the tape is performed by the processing at Steps S31 to S59.

At Step S31, in the same manner as at Step S5 described above, the CPU 401 checks whether the length that has been set as the length N of the leading margin is at least L3 (25 millimeters). If the length N is at least L3 (YES at Step S31), processing of Steps S51 to S59 is performed. In this case, the portion of the tape that remains between the thermal head 10 and the cutting mechanism 17 after the previous round of the printing will be used without any waste as the leading margin in the current round of the printing. Therefore, in this case, the processing that will be sequentially performed at Steps S51, S53, S55, S57, and S59 is identical to the processing at the previously explained Steps S21, S23, S25, S27, and S29, respectively, regardless of which mode is set. Accordingly, the explanation of Steps S51 to S59 in the case where the length N of the leading margin has been set to at least L3 will be omitted, as the explanation of Steps S21 to S29 applies mutatis mutandis.

If a length that is less than L3 (25 millimeters) has been set as the length N of the leading margin (NO at Step S31), processing of Steps S33 to S49 (or S59) are performed. More specifically, if the mode has been set to the normal mode, the result of determination processing at Steps S35 and S47 as to whether the economy mode has been set is NO, so the sequence of the processing that is therefore performed at Steps S33, (NO at Step S35), S41, S43, S45, (NO at Step S47), and S59 is identical to the processing at the previously explained Steps S7, S9, S11, S13, and S15, respectively. Accordingly, the explanation of Steps S33 to S59 that are performed in the case of the normal mode will be omitted, as the explanation of Steps S7 to S15 applies mutatis mutandis, and the processing at Steps S33 to S49 that are performed in the case of the economy mode will be explained below. A concrete example of the processing at Steps S33 to S49 is shown in FIG. 11.

As shown in FIG. 8, in a case where the length N of the leading margin has been set to less than L3 (NO at Step S31), the length N is overwritten and reset to L3 (25 millimeters), in the same manner as at Step S7 (Step S33). The feed state of the tape at this time is shown at stage 1 in FIG. 11. Because the mode has been set to the economy mode (YES at Step S35), the tape feed motor 23 is driven in reverse (Step S37). The tape is fed upstream in relation to the feed direction by the tape conservation amount α (millimeters), and the driving of the tape feed motor 23 is stopped (Step S39). The feed state of the tape at this time is shown at stage 2 in FIG. 11. The leading end of the tape is located at a position that is α millimeters upstream from the cutting position (C) in relation to the feed direction. From this position, the tape feed motor 23 is driven forward (Step S41), and the printing is performed as the tape is fed (Step S43). The length N of the leading margin thus effectively becomes equal to L3 minus α (L3−α) millimeters, and the amount of the tape consumed is reduced by the conservation amount α (millimeters).

When the tape has been fed by the length of the printing area that is set according to the printing data, the printing is stopped (Step S45). The feed state of the tape at this time is shown at stage 3 in FIG. 11. Because the mode has been set to the economy mode (YES at Step S47), the tape is fed by an amount that is equal to L3 minus α (L3−α), in order to ensure the trailing margin (Step S49). The feed state of the tape at this time is shown at stage 4 in FIG. 11. The processing proceeds to Step S61, after the tape has been fed by the additional length L3, the driving of the tape feed motor 23 is stopped (Step S61), and the CPU 401 returns to the processing according to the main program. In this state, the cutting mechanism 17 is driven according to another program, and when the tape is cut off, a tape with a good appearance is created that has a leading margin of the length L3 minus α (L3−α) on the leading side of the printing area and in the same manner, has a trailing margin of the length L3 minus α (L3−α) on the trailing side, as indicated at stage 5 in FIG. 11.

As explained above, in the tape printer 1 according to the present embodiment, the film tape 59 can be pinched between the movable feed roller 14 and the tape feed roller 46 in the nip portion 33 and can be guided to the tape channel 63 in the direction of the tape discharge outlet 49 of the laminated tape restricting member 60. Thus, if the tape conservation amount α is set to be shorter than the length L4 between the nip portion 33 and the tape discharge outlet 49, the leading end of the film tape 59 (the downstream end in relation to the feed direction) can be prevented from coming out of the nip portion 33, even if the tape feed motor 23 is driven in reverse and the film tape 59 is fed upstream in relation to the feed direction. Furthermore, feeding the film tape 59 upstream prior to the printing can make it possible to make the length of the portion that will definitely be consumed on the leading side of the printing area of the film tape 59 in a single round of the printing to be shorter by the tape conservation amount α that the film tape 59 is fed upstream.

Further, if the length L1 of the tape channel 63 of the laminated tape restricting member 60 is used as the reference length and the tape conservation amount α is set to be shorter than the length L1, it may be possible to prevent the leading end of the film tape 59 (the downstream end in relation to the feed direction) from coming out of the tape channel 63, even if the film tape 59 is fed upstream by driving the tape feed motor 23 in reverse. Alternatively, the distance L2 between the restricting wall 43 and the outer circumferential surface 45 of the tape feed roller 46 may be used as the reference length and the tape conservation amount α may be set to be shorter than the distance L2. In this case, even if the laminated type tape cassette 30 has been mounted in the tape printer 1 and the film tape 59 is fed upstream by driving the tape feed motor 23 in reverse, it may be possible to prevent a jam that may be caused by the double-sided adhesive tape 58 that is affixed to the film tape 59 striking and adhering to the restricting wall 43.

Because the greater-than and less-than relationships among L1, L2, and L4 that may each serve as the reference length vary according to the design of the tape printer 1, it may be preferable for the shortest one of L1, L2, and L4 to be used as the reference length for the tape conservation amount α. Furthermore, if the tape conservation amount α is made close to the reference length, it may be possible to ensure that the tape conservation amount α is as long as possible. In the tape printer 1 according to the present embodiment, the length L4 is the longest, the length L1 is the second longest, and the distance L2 is the shortest (L4>L1>L2). Therefore, as in the case of the present embodiment, if the distance L2 is used as the reference length and the tape conservation amount α is set to be shorter than L2, even if the film tape 59 is fed upstream by driving the tape feed motor 23 in reverse, the leading end of the film tape 59 can be prevented from coming out of the tape channel 63 and the nip portion 33, and the double-sided adhesive tape 58 can also be prevented from striking and adhering to the restricting wall 43.

In a case where the length N that is set as the leading margin is at least the length L3 between the printing position of the thermal head 10 and the cutting position of the cutting mechanism 17, the printing is started after the film tape 59 is fed such that the length from the leading end of the film tape 59 to the printing position becomes the length of the leading margin. Therefore, the portion of the film tape 59 that remains between the printing position and the cutting position prior to the printing can be used as is for the leading margin, without generating any waste.

In contrast, in a case where the length N of the leading margin is less than L3, the printing is started after the film tape 59 is fed in reverse, such that the length from the leading end of the film tape 59 to the printing position becomes the length of the leading margin. Therefore, in the portion of the film tape 59 that remains between the printing position and the cutting position prior to the printing, the length of the portion that protrudes from the portion that can be used for the leading margin can be reduced. The portion of the film tape 59 that remains between the printing position and the cutting position is the portion that will definitely be consumed in a single round of the printing. Instead of simply feeding the film tape 59 and cutting off the portion that protrudes from the leading margin, the film tape 59 is fed in reverse and the excess portion is effectively utilized by being incorporated into the printing area, it may be possible to reduce the waste in the consumption of the tape.

In the tape printer 1, at the point when the previous round of the printing is completed, the leading end of the film tape 59 is normally at the cutting position of the cutting mechanism 17. On the other hand, in a case where the power supply for the tape printer 1 has been turned off or the tape cassette 30 has been removed in the interval between the previous round of the printing and the current round of the printing, if the user inadvertently touches the leading end of the film tape 59, for example, the film tape 59 may move in the upstream direction. Therefore, in this sort of situation, the film tape 59 will not be fed upstream prior to the printing. Therefore, it may be possible to prevent the leading end of the film tape 59 from coming out of the tape channel 63 and the nip portion 33 and also to prevent the double-sided adhesive tape 58 from striking and adhering to the restricting wall 43.

In the present embodiment, if the length of the leading margin in the economy mode is set to L3 minus α (L3−α), the length of the trailing margin can also be set to L3 minus α (L3−α), and if the length of the leading margin in the normal mode is set to L3, the length of the trailing margin can also be set to L3. Therefore, the sizes of the margins that are formed ahead of and behind the printing area of the tape that is created can be made the same, improving the appearance of the tape.

The tape cassette 30 and the tape printer 1 disclosed in the above explained embodiment can be modified variously.

For example, each of the first and second members 61 and 62 of the laminated tape restricting member 60 is a columnar member that is continuously formed from the bottom to the top of the tape cassette 30. The shape of these members, however, is not limited to this example. The first member 61 may be formed by an upper restricting member that protrudes downward from the top case 31A and a lower restricting member that protrudes upward from the bottom case 31B, for example. There may be a gap between the upper restricting member and the lower restricting member. In addition, the second member 62 may be modified in a similar manner.

In the embodiment, the laminated type tape cassette 30 in which the double-sided adhesive tape 58, the film tape 59 and the ink ribbon 52 are mounted is explained as an example of the tape cassette. The tape cassette 30 may be configured as a so-called thermal laminated type tape cassette that includes the cassette case 31 in which the double-sided adhesive tape 58 wound on the first tape spool 40 and a heat-sensitive paper tape wound on the second tape spool 41 are mounted, but the ink ribbon is not mounted.

In the tape cassette 30 of the embodiment, the length L1 of the tape channel 63 is longer than the distance L2 between the restricting wall 43 and the outer circumferential surface 45 of the tape feed roller 46 (L1>L2). In this case, even if the film tape 59 or the laminated tape 50 is pushed upstream in relation to the feed direction when the tape cassette 30 is not installed in the tape printer 1, the leading end of the laminated tape 50 can be prevented from coming out of the tape channel 63. However, when only the conservation of the tape due to controlling the feeding by the tape printer 1 is considered, L1 may be shorter than L2. This can be accomplished, for example, by one of reducing the outside diameter of the tape feed roller 46 and disposing the position of the restricting wall 43 farther away from the outer circumferential surface 45 of the tape feed roller 46. In this case, L1 may be used as the reference length for the setting of the conservation amount α for the tape printer 1. Similarly, with regard to the length L4 between the nip portion 33 and the tape discharge outlet 49, the setting of the conservation amount α may be performed appropriately in accordance with the design of the tape printer 1, as described in the embodiment.

In the processing according to the tape feed program, the tape feed motor 23 may be driven in reverse in accordance with various types of conditions, such as the state of the mode setting, the on/off state of the power supply, the presence or absence of the tape cassette 30, the set value for the length N of the leading margin, and the like, but whether or not these conditions are used and in what combination is left to the user's discretion. For example, the conditions may be set such that the conserving of the amount of the tape to be consumed (that is, the feeding of the tape in the upstream direction prior to the printing) may always be performed if the length N of the leading margin is less than L3.

In the embodiment, a case was explained in which the laminated type tape cassette 30 that contains the double-sided adhesive tape 58, the film tape 59, and the ink ribbon 52 was installed in the tape printer 1. However, a tape cassette in which a double-sided adhesive tape is wound on a first tape spool and a heat-sensitive paper tape that is made of one of a transparent and an opaque film is wound on a second tape spool may also be used in the tape printer 1. Alternatively, the double-sided adhesive tape may also be omitted, and one of a tape cassette that contains a heat-sensitive paper tape that is combined with an adhesive tape and a tape cassette that contains an ink ribbon and a printing tape that is combined with an adhesive tape may also be used.

The tape printer 1 according to the above explained embodiment can be recognized as a tape printer that includes a tape cassette, a cassette housing portion, a feeding device, and a printing device. The tape cassette includes a cassette case, a tape, a first restricting member, and a first roller. The cassette case has a top face, a bottom face, a front face, and a pair of side faces. The tape is a printing medium that is mounted within the cassette case and that is fed along a first feed path within the cassette case. The first restricting member is provided at a downstream end of the first feed path. The first restricting member has a channel through which the tape passes and, at a downstream end of the channel, a discharge outlet through which the tape is discharged to an outside of the cassette case. The first restricting member is adapted to restrict a movement of the tape in a thickness direction of the tape with two faces of inner faces of the channel, the two faces being disposed on opposite sides of the tape that passes through the channel, in relation to the thickness direction of the tape. The first roller is rotatably supported on an upstream side of the restricting member on the first feed path. The tape cassette can be installed in or removed from the cassette housing portion. The feeding device includes a second roller that feeds the tape in a feed direction, and feeds the tape along the first feed path. The printing device performs printing on the tape that is fed by the feeding device. Further, the first roller pinches the tape with the second roller in a nip portion and guides the tape to the channel by operating in conjunction with the second roller. The feeding device, before the printing device starts the printing on the tape, feeds the tape along the first feed path in an upstream direction by a first length that is shorter than a length between the nip portion and the discharge outlet.

In the tape printer, the feeding device may feed the tape along the first feed path in the upstream direction by a second length that is shorter than a length of the channel.

In the tape printer, the tape cassette may further include a double-sided adhesive tape and a second restricting member. The double-sided adhesive tape may be fed along a second feed path, and may be affixed to the tape at the nip portion. A portion of the second feed path is along a portion of an outer circumferential surface of the first roller, and the second feed path converges with the first feed path at the nip portion. The second restricting member may face the portion of the outer circumferential surface of the first roller that is the portion of the second feed path, and may be disposed in a radially outward direction with respect to the first roller such that the second restricting member is separated from the outer circumferential surface by a third length. The second restricting member may be adapted to restrict a movement of the double-sided adhesive tape in the radially outward direction. Further, the feeding device may feed the tape along the first feed path in the upstream direction by the shorter of the second length and a fourth length that is shorter than the third length.

The third length between the second restricting member and the outer circumferential surface of the first roller may be shorter than the length of the channel of the first restricting member. Further, the feeding device may feed the tape along the first feed path in the upstream direction by the fourth length.

The tape printer may further include a cutting device that is disposed on a downstream side of the discharge outlet on the first feed path of the tape and that cuts the tape, and a margin setting device that sets lengths of margins that are provided ahead of and behind in relation to the feed direction of the tape, a portion of the tape on which the printing is performed. In this case, the feeding device may feed the tape along the first feed path in the upstream direction before the printing on the tape starts, in a case where the lengths of margins that are set by the margin setting device are less than a fifth length between the printing device and the cutting device. The feeding device may not feed the tape along the first feed path in the upstream direction before the printing on the tape starts, in a case where the lengths of margins are at least the fifth length.

The tape printer may further include a first monitoring device that monitors a change between an on state and an off state of a power supply to the tape printer. In this case, the feeding device may not feed the tape along the first feed path in the upstream direction before the printing on the tape starts, even if the lengths of margins are less than the fifth length, in a case where the printing on the tape is started for the first time after a change in the power supply from the off state to the on state is detected by the first monitoring device.

The tape printer may, further include a second monitoring device that monitors a change between a state in which the tape cassette has been installed in and a state in which the tape cassette has been removed from the cassette housing portion. In this case, the feeding device may not feed the tape along the first feed path in the upstream direction before the printing on the tape starts, even if the lengths of margins are less than the fifth length, in a case where the printing on the tape is started for the first time after a change from the removed state to the installed state of the tape cassette is detected by the second monitoring device.

The tape printer may further include an economy mode setting device that makes a setting to reduce an amount of the tape to be consumed in a single round of the printing. In this case, the feeding device may feed the tape along the first feed path in the upstream direction before the printing on the tape starts, and after the tape has been printed, feed the tape along the first feed path in the downstream direction by a sixth length that is computed by subtracting from the fifth length a length that the tape was fed along the first feed path in the upstream direction before the printing, in a case where the lengths of margins are less than the fifth length and the setting to reduce the amount of the tape to be consumed has been made. The feeding device may not feed the tape along the first feed path in the upstream direction before the printing on the tape starts, and after the tape has been printed, feed the tape along the first feed path in the downstream direction by the fifth length, in a case where the lengths of margins are less than the fifth length and the setting to reduce the amount of the tape that is consumed has not been made. In this case, the CPU 401 that, at Step S1 in the processing shown in FIG. 8, reads the mode (one of the economy mode and the normal mode) that has been set by the user corresponds to an “economy mode setting device”.

In the tape printer, the first restricting member may include a first face side restricting member that has a first face that is one of the two faces, and a second face side restricting member that has a second face that is the other of the two faces. In this case, the first face side restricting member may be disposed toward an inside of the cassette case in relation to the second face side restricting member. An upstream edge of the first face in relation to the feed direction may be located farther upstream than is an upstream edge of the second face in relation to the feed direction.

In the tape printer, the second face of the second face side restricting member may include an inclined face on the upstream end side, the inclined face inclining in a direction away from the tape from the downstream side toward the upstream side in relation to the feed direction.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A tape cassette, comprising:
a cassette case that has a top face, a bottom face, and a side face;
a printing tape as a printing medium that is mounted within the cassette case and fed along a specified first feed path within the cassette case;
a double-sided adhesive tape that is mounted within the cassette case and fed along a specified second feed path within the cassette case, the double-sided adhesive tape having two surfaces, one of the two surfaces having a release material removably affixed thereto, and the other of the two surfaces being affixable to the printing tape;
a cylindrical tape feed roller that has an outer circumferential surface and an axis extending in a vertical direction of the cassette case, that is supported by the cassette case, and that guides the double-sided adhesive tape along a section of the outer circumferential surface on the second feed path, a length of the section in a circumferential direction being equal to or longer than a quarter of a length of the outer circumferential surface in the circumferential direction;
a laminated tape restricting member that is provided on a downstream side of the tape feed roller on the first feed path and the second feed path, and at downstream ends of the first feed path and the second feed path where the first feed path and the second feed path overlap each other, the laminated tape restricting member including:
a first member that has a first face;
a second member that is disposed to oppose the first member in a position that is farther from the tape feed roller than is the first member, and that has a second face that is generally parallel to the first face;
a channel that is formed between the first face of the first member and the second face of the second member, an upstream edge of the second face in a feed direction of a laminated tape passing through the channel being located farther downstream than an upstream edge of the first face in the feed direction, the laminated tape being a tape formed by the printing tape and the double-sided adhesive tape affixed to the printing tape; and
a tape discharge outlet that is located at a downstream end of the channel, the laminated tape being discharged through the tape discharge outlet to an outside of the cassette case, and
an adhesive tape restricting member that is disposed to oppose the section of the outer circumferential surface along which the double-sided adhesive tape is guided, and that is disposed apart from the outer circumferential surface by a distance that is shorter than a length of the channel of the laminated tape restricting member.

2. The tape cassette according to claim 1, wherein the second face of the second member includes an inclined face at an upstream end thereof in the feed direction, the inclined face inclining away from the laminated tape from a downstream side toward an upstream side in the feed direction.

3. The tape cassette according to claim 1, wherein the first face and the second face are adapted to restrict a movement of the laminated tape in a direction that is perpendicular to surfaces of the laminated tape passing through the channel.

4. The tape cassette according to claim 1, wherein the adhesive tape restricting member is adapted to restrict a movement of the double-sided adhesive tape in a radially outward direction of the tape feed roller.

5. A tape cassette, comprising:
a cassette case that has a top face, a bottom face, and a side face;
a printing tape as a printing medium that is mounted within the cassette case and fed along a specified first feed path within the cassette case;
a double-sided adhesive tape that is mounted within the cassette case and fed along a specified second feed path within the cassette case, the double-sided adhesive tape having two surfaces, one of the two surfaces having a release material removably affixed thereto, and the other of the two surfaces being adapted to be affixed to the printing tape;
a cylindrical tape feed roller that has an outer circumferential surface and an axis extending in a vertical direction of the cassette case, that is supported by the cassette case, and that is adapted to guide the double-sided adhesive tape along a section of the outer circumferential surface on the second feed path, a length of the section in a circumferential direction being equal to or longer than a quarter of a length of the outer circumferential surface in the circumferential direction;
a laminated tape restricting member that is provided on a downstream side of the tape feed roller on the first feed path and the second feed path, and at downstream ends of the first feed path and the second feed path where the first feed path and the second feed path overlap each other, the laminated tape restricting member including:
a first member that has a first face;
a second member that is disposed to oppose the first member in a position that is farther from the tape feed roller than is the first member, and that has a second face that is generally parallel to the first face;
a channel that is formed between the first face of the first member and the second face of the second member, the first face and the second face being adapted to restrict a movement of a laminated tape in a direction that is perpendicular to surfaces of the laminated tape passing through the channel, an upstream edge of the second face in a feed direction of the laminated tape being located farther downstream than an upstream edge of the first face in the feed direction, the laminated tape being a tape formed by the printing tape and the double-sided adhesive tape affixed to the printing tape; and
a tape discharge outlet that is located at a downstream end of the channel, the laminated tape being discharged through the tape discharge outlet to an outside of the cassette case, and
an adhesive tape restricting member that is disposed to oppose the section of the outer circumferential surface along which the double-sided adhesive tape is guided, and that is disposed apart from the outer circumferential surface by a distance that is shorter than a length of the channel of the laminated tape restricting member, the adhesive tape restricting member being adapted to restrict a movement of the double-sided adhesive tape in a radially outward direction of the tape feed roller.

6. The tape cassette according to claim 5, wherein the second face of the second member includes an inclined face at an upstream end thereof in the feed direction, the inclined face inclining away from the laminated tape from a downstream side toward an upstream side in the feed direction.
